(19) United States
(12) Patent Application Publication
(10) Pub. No.: US 2023/0090434 A1
(43) Pub. Date: Mar. 23, 2023

(54) Open Contactor Bypass Circuit For A Battery System

(71) Applicant: K2 ENGERGY SOLUTIONS, INC., Henderson, NV (US)

(72) Inventor: Walter Bacharowski, Las Vegas, NV (US)

(21) Appl. No.: 17/801,474

(22) PCT Filed: Mar. 24, 2020
(86) PCT No.: PCT/US2021/023925

§ 371 Date: Aug. 22, 2022

Related U.S. Application Data
(60) Provisional application No. 62/956,537, filed on Jan. 2, 2020.

(51) Int. Cl. H02J 7/00; H01M 10/42

(52) U.S. Cl. CPC H02J 7/0016; H02J 7/0031; H01M 10/425; H02J 7/00306; H01M 2010/4271

(57) ABSTRACT

An open contactor bypass system for a battery is disclosed. The battery system has a positive and a negative output terminals, a battery management system, and a latching contactor in series with the positive and negative terminals. The latching contactor is operable between an open state and a closed state, under control of the battery management system. The open contactor bypass circuit may permit charging of the battery when the battery is coupled to a battery charger and the latching contactor is in the open state. The open contactor bypass circuit may comprise a bypass circuit disposed across the latching contactor for permitting charging current from the battery charger to flow through the bypass circuit, to bypass the open state contactor and charge the battery.

### BACKGROUND

Certain batteries use a switching device, such as a latching contactor, as an isolation element in a battery protection circuit.

As is known, such latching contactors typically respond to a pulse of sufficient magnitude to move the contactor between alternating states, i.e., from an open state to a closed state, and/or from a closed state to an open state. Once moved from one state to the other state, no further holding current is required, and the contactor will remain in position until another pulse of sufficient magnitude causes the contactor to move back to the first state.

The contactor associated with such batteries will typically be closed under normal operating conditions, thereby providing power to output terminals of the battery. However the contactor may be opened, thereby protecting the battery, in certain situations, such as when a short circuit is detected, when a battery over-discharge is detected, or when battery overcharging is detected.

It has been found that in certain situations, there have been occurrences of battery failures due to a low state of charge, and the batteries, having a low state of charge, being unable to generate a pulse of sufficient magnitude to close the contactor when a battery charger was subsequently connected to the battery terminals. And because the contactor could not be closed, the battery charger was prevented from recharging the battery.

The present disclosure is provided to address this and other problems.

### SUMMARY

It is an object to provide a contactor bypass circuit to supply a small charging current to the battery when the contactor is open and a charger is connected to the battery's terminals.

It is contemplated the contactor bypass circuit may only supply current to the battery when the contactor is open. When the battery's state of charge is sufficient to close the contactor, closure of the contactor will allow the full charging current to flow into the battery, through the contactor terminals, and continue to charge the battery. When the contactor is closed, the contactor bypass circuit may be disabled.

This and other objectives and advantages may become apparent from the following description taken in conjunction with the accompanying Figures.

### DESCRIPTION OF THE FIGURES

FIG. 1 is a simplified block diagram of a conventional battery management system (BMS) and a latching contactor;

FIG. 2 is a block diagram of the BMS and contactor of FIG. 1, including a contactor bypass circuit in accordance with a passive embodiment of the present invention;

FIG. 3 is a schematic diagram of one embodiment of the contactor bypass circuit of FIG. 2;

FIGS. 4A-4D are schematic diagrams of alternative embodiments of the contactor bypass circuit of FIG. 2.

FIG. 5 is block diagram of the BMS and contactor of FIG. 1, including a contactor bypass circuit in accordance with an active embodiment of the present invention;

FIG. 6A-6B are schematic diagrams of alternative embodiments of the active embodiment of FIG. 5;

FIG. 7A-7D are further alternative embodiments of the active embodiment of FIG. 5;

FIGS. 8A-8D are still further alternative embodiments of the active embodiment of FIG. 5; and

FIGS. 9A-9D are still further alternative embodiments of the active embodiment of FIG. 5.

### DESCRIPTION OF THE PREFERRED EMBODIMENTS

While this invention is susceptible of embodiments in many different forms, there will be described herein in detail, specific embodiments thereof with an understanding that the present disclosure is to be considered an exemplification of the principles of the invention and is not intended to limit the invention to the specific embodiments illustrated.

As is known with batteries, such as lithium-ion batteries having one or more lithium-ion battery cells, over-discharged batteries should preferably be initially slowly recharged so as to prevent, or otherwise minimize, further damage to the cells of the battery.

According to certain embodiments of the present bypass circuit, a small charging current may be provided to a battery in a situation when a protection contactor is open and the battery is in a low state of charge and is not able to generate a pulse of sufficient magnitude to close the contactor when a charger is connected to the external terminals of the battery. The charging current may slowly increase the state of charge of the battery, and after a period of time, the state of charge of the battery will be of sufficient magnitude such that the BMS will be able to generate a pulse of sufficient magnitude to close the contactor.

According to certain embodiments of the present bypass circuit, the charging current is limited to a rate not detrimental to the over-discharged battery cells.

According to certain embodiments of the present bypass circuit, when the contactor closes, the contactor bypass circuit may be disabled, and the full charging capacity of the battery charger may be applied to the battery.

The bypass circuit may include a current source disable circuit, which may allow the BMS to turn off the bypass the circuit. The shutdown function of the current source disable circuit, under control of a battery management system (or BMS), may prevent overcharging of the battery. When the battery is fully charged, the BMS may open the contactor to disable additional charging. In certain situations, if the bypass circuit did not have the shutdown function, the battery could potentially continue to charge and potentially be overcharged.

The bypass circuit may be provided to be used in batteries that use a latching contactor, or other switching device, as an isolation element, such as in the battery protection circuit. The battery protection circuit may be provided to open when the battery is close to being over discharged, over charged, or in over current conditions such as a short circuit at the battery's terminals.

In an over discharged situation, and when the contactor has opened, the battery may not be recharged for some period of time, during which the battery may continue to slowly discharge due to a small current that the BMS may consume, as well as through self-discharge of the battery's cells. In this case the battery can reach a state of charge in which the contactor cannot be closed when a charger is connected to terminals of the battery, and the battery may become unusable. At this point the battery may have been damaged by over discharging it, but the battery may be at least partially recoverable if a small charging current is supplied to the battery.

Certain embodiments of the contactor bypass circuit of the present invention may use a voltage difference between voltage of the battery charger and the voltage of the battery, when the contactor is open, to provide a small constant charging current to the battery to start recharging it.

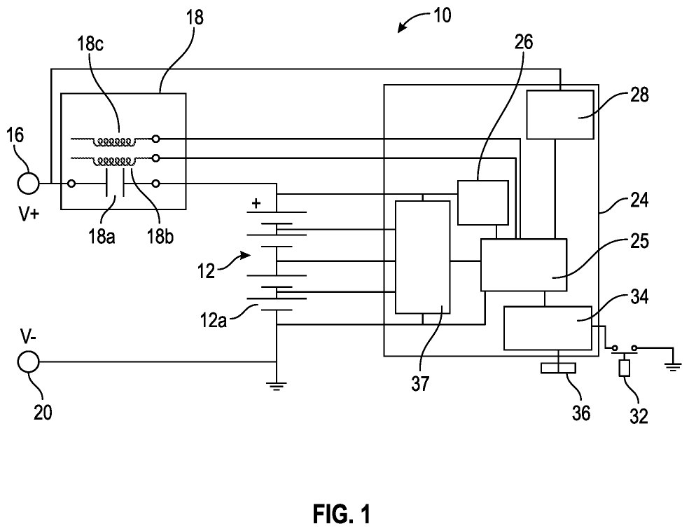

A conventional battery system, generally designated 10, is illustrated in FIG. 1. The battery system 10 may include a battery 12, which may comprise one or more battery cells 12a. Four of the battery cells 12a are illustrated in FIG. 1. The battery cells 12a may be lithium-ion battery cells. While the embodiment disclosed herein is of a battery system with battery cells as rechargeable energy storage devices, the disclosure may be equally applicable to energy storage devices such as high-capacity capacitors.

The battery 12 may be coupled to a positive output terminal 16, via a switching device. The switching device may be a conventional latching relay 18 having a contactor 18a. The latching relay 18 may also include an unlatching open coil 18b and a latching closed coil 18c. The contactor 18a may be selectively operable upon inputs to either the unlatching open coil 18b or the latching closed coil 18c, as is known. The battery 12 may also be coupled to a negative output terminal 20. The positive and negative output terminals 16, 20, may be coupled to, and thereby provide DC power to, a load (not shown). A conventional battery charger (not shown) may at times be conventionally coupled to the positive and negative output terminals 16, 20, such as to charge the battery cells 12a.

The battery system 10 may also include a battery management system, or BMS, 24. The BMS 24 may operate under control of a conventional controller 25, such as an STM32L051 microcontroller, provided by STMicroelectronics, Geneva, Switzerland.

The BMS 24 may include a conventional power supply circuit 26, coupled to the battery 12 and the controller 25, to provide regulated power to the BMS 24, including the controller 25.

The BMS 24 may also include a charger detect circuit 28, coupled between the positive output terminal 16 and the controller 25, to permit the controller 25 to detect when an active battery charger has been coupled to the positive and negative output terminals 16, 20.

The BMS 24 may further include an input switch 32, such as a pushbutton switch, coupled to a input switch input circuit 34, to detect actuation of the input switch 32. The input switch 32 may be used as an input to the controller 25. The BMS 24 may still further include a display 36, such as to indicate the state of the BMS 24.

The BMS 24 may still include a cell voltage balancing circuit 37, for monitoring the voltage across, and charging of, each of the individual battery cells 11a. More detail of the voltage balancing circuit 37 may be found in US Pat. Pub. No. US 2011/0089902. Further detail regarding operation of a known BMS may be found in U.S. Pat. No. 10,326,286.

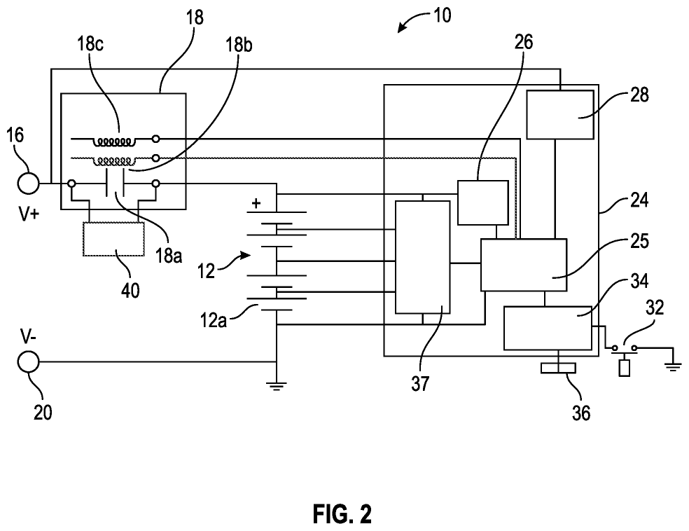

A passive bypass circuit, generally designated 40, coupled across the latching relay 18a, is illustrated in FIG. 2, where reference numbers common to FIG. 1 have been maintained.

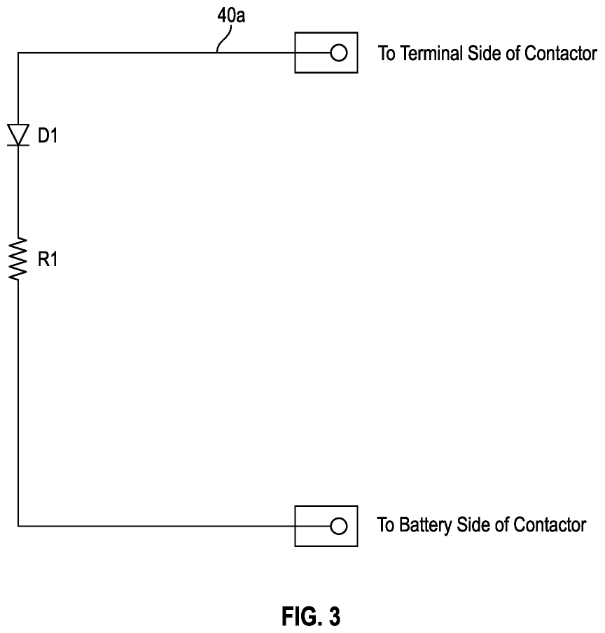

A first passive embodiment 40a of the passive bypass circuit 40, is illustrated in FIG. 3. The first passive embodiment 40a includes a diode D1 and a resistor R1. Referring to FIGS. 2 and 3, when the contactor 18a is open, and a charger is connected to the terminals 16, 20, a battery charging current may flow through the diode D1 and the resistor R1, which may provide a charging current to the battery 12. When the state of charge of the battery 12 is determined by the BMS 24 to be sufficiently restored, the BMS 24 may close the contactor 18a, allowing substantially all of the charging current to flow through the contactor 18a into the battery 12. This embodiment does not have a method to stop, or turn OFF, the charging of the battery 12, once the battery 12 has reached its full charge, which may be a drawback in certain situations.

To prevent or otherwise minimize the potential of overcharging of the battery 12, the resistance magnitude of the resistor R1 may be selected to be sufficiently high to limit the current flow to the battery 12 to a value less than the balance current used for the battery cells. When the battery 12 is fully charged and the contactor 18a opens to prevent further charging, the current flowing through the bypass circuit may be diverted around the battery by the cell balance circuit 37 and prevent overcharging of the battery 12, but the current should preferably be less than the balance current.

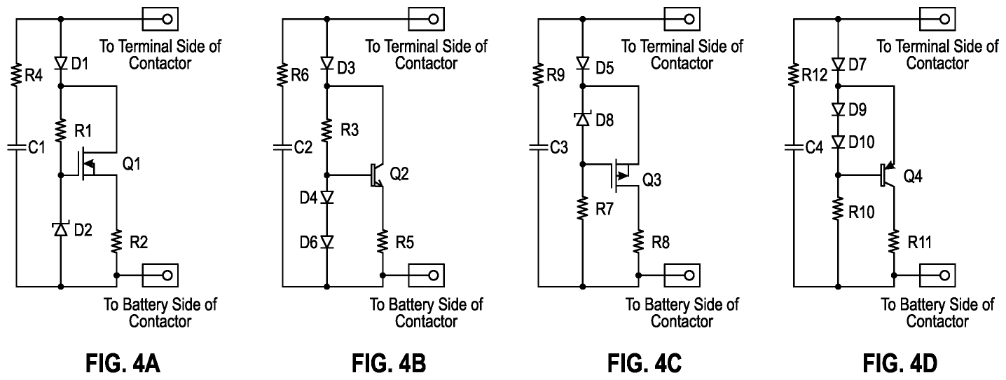

FIGS. 4A-4D illustrate four enhanced implementations of the passive bypass circuit 40, using four common transistor types. FIG. 4A illustrates a current source implemented with a NMOS transistor. FIG. 4B illustrates a current source implemented with an NPN transistor. FIG. 4C illustrates a current source implemented with a PMOS transistor. FIG. 4D illustrates a current source implemented with a PNP transistor.

The circuits illustrated FIGS. 4A-4D are variations of implementations of constant current sources disposed between the terminal side of the contactor 18a and the battery side of the contactor 18a. An advantage of a constant current type contactor bypass circuit is the current to restore the battery's state of charge may be maintained substantially constant and independent of the charger's voltage. These implementations of the passive bypass circuit 40 do not have a shutdown feature, so the amount of current the constant current circuit passes is preferably less than the balance current used to balance the cells. This may prevent the battery 12 from being over charged when the contactor opens, due to the battery being fully charged, and the contactor 18a opens to prevent additional charging of the battery.

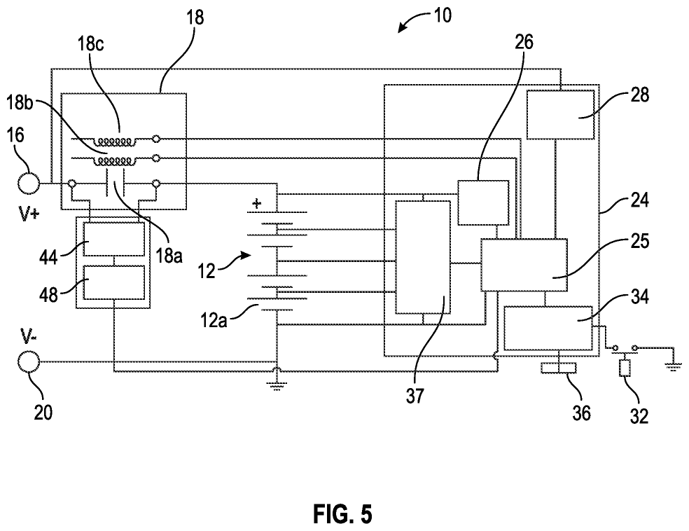

An active bypass circuit, generally designated 44, coupled across the latching relay 18a, is illustrated in FIG. 5, where reference numbers common to FIGS. 1 and 2 have been maintained. The active bypass circuit 44 is herein referred to as active, as includes a shutdown circuit 48 coupled to, and operable under the control of, the controller 25. The shutdown circuit 48 is adapted to prevent current from flowing from the charger, through the bypass circuit, and charging the battery 12, such as when the battery 12 is determined to be fully charged.

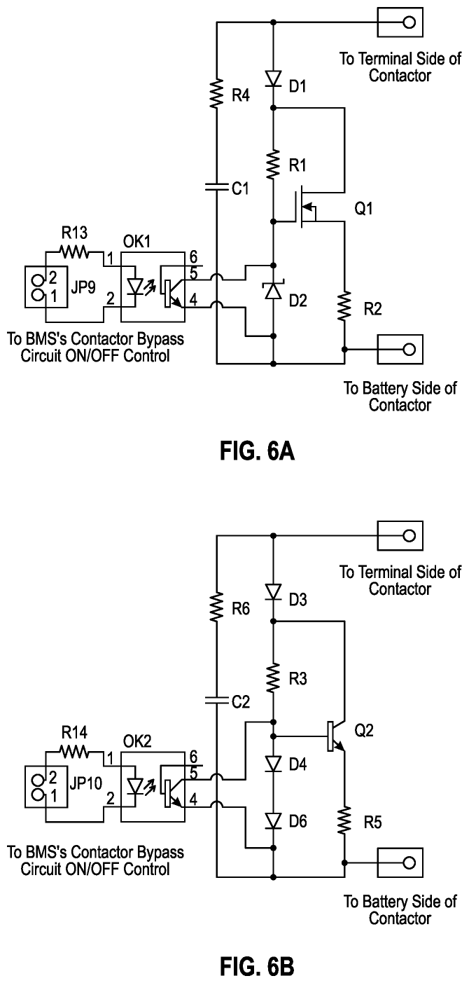

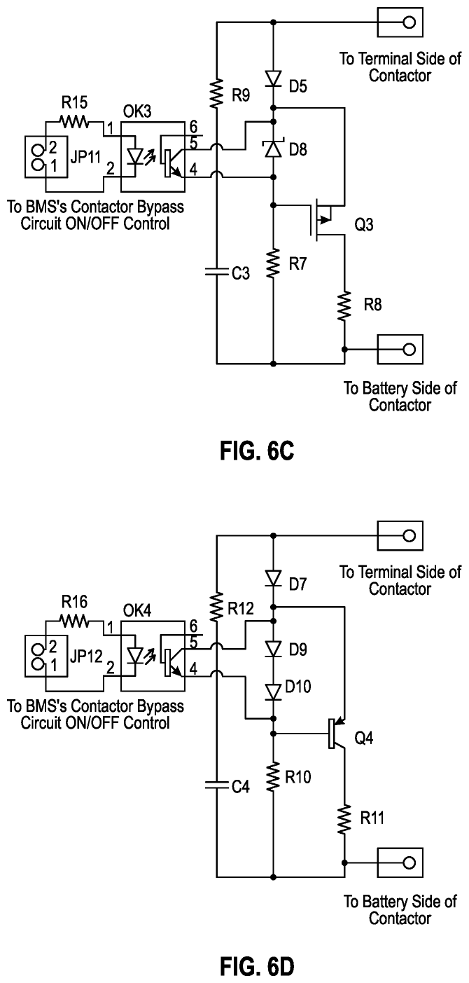

Referring to FIGS. 6A-6D, the passive bypass circuits of FIGS. 4A-4D having respective constant current sources are illustrated, modified so as to include the shutdown circuit 48 coupled to the controller 25.

FIGS. 6A-6D illustrate the current sources from respective FIGS. 4A-4D, with the shutdown circuit 48 including opto-isolators OK1, OK2, OK3, OK4, respectively, added to them. The opto-isolators may be a 4N35 optocoupler. The shutdown circuit 48 may be provided to disconnect the bypass circuit 44 at an appropriate time under the control of the controller 25, such as by removing the transistor drive from the respective transistors (i.e., the base drive of the bipolar transistors Q1, Q2, and the gate drive of the MOSFET transistors Q3, Q4).

The shutdown circuit 48 of FIGS. 6A-6D functions by removing the transistor drive (i.e., base drive or gate drive) when the controller 25 of the BMS 24 applies a voltage to the LED side of the opto-isolators. This turns ON the respective transistor on the output side of the respective opto-isolator, which removes the drive from the current regulating transistor (Q1, Q2, Q3, Q4, respectively).

While the shutdown circuit 48 of FIGS. 6A-6D may be composed of an opto-isolator, any isolation circuit that may affect the gate or base drive of the current regulating transistor may be considered as a variation of this shutdown control circuit. There may be many possible variations of this shutdown scheme.

A feature of the shutdown circuit 48 shown in FIGS. 6A-6D is that the current flow in the bias circuit for the current regulator transistor does not stop when the shutdown function is active. This is the current flow through the resistor and diodes connected to the gate or base of the regulator transistor and is substantially less than the current flow through the regulator transistor, and less than the balance current used the battery's cell balance circuit. This small current may be used as a trickle charge current to keep the battery in a full state of charge while the charger is connected.

Referring to FIG. 6A, components R1, R2, D1, D2, and Q1, may implement the constant current source to provide the small charging current to the battery 12. The magnitude of the small charging current may be determined by the resistance of R2, the voltage of Zener diode D2, and the threshold voltage of the transistor Q1. The magnitude of the current may be designed to be a value appropriate for the battery's type and capacity. After a period of time, the battery's state of charge may have increased sufficiently for the BMS 24 to close the contactor 18a, which then may disable the bypass circuit, providing the full charging current to the battery 12.

To avoid overcharging the battery 12, the bypass circuit may include a shutdown feature. When the battery is being charged, and it has reached a full state of charge, the contactor is opened to discontinue the charging. If the contactor has a bypass circuit connected, the battery 12 would continue to be charged. In FIG. 6A, the BMS 24 may disable the bypass circuit through the opto-isolator OK1, which removes the gate voltage on Q1, and turns OFF the bypass circuit.

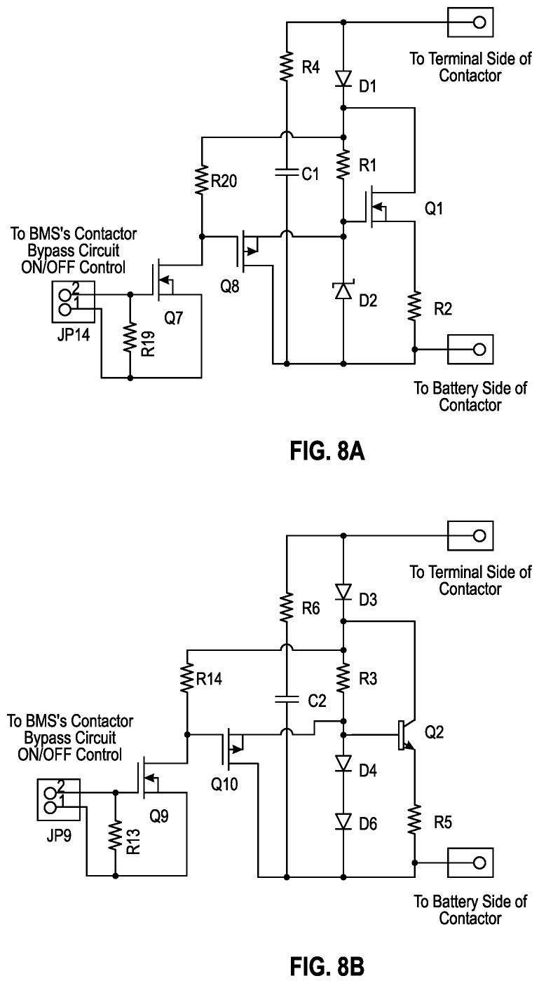

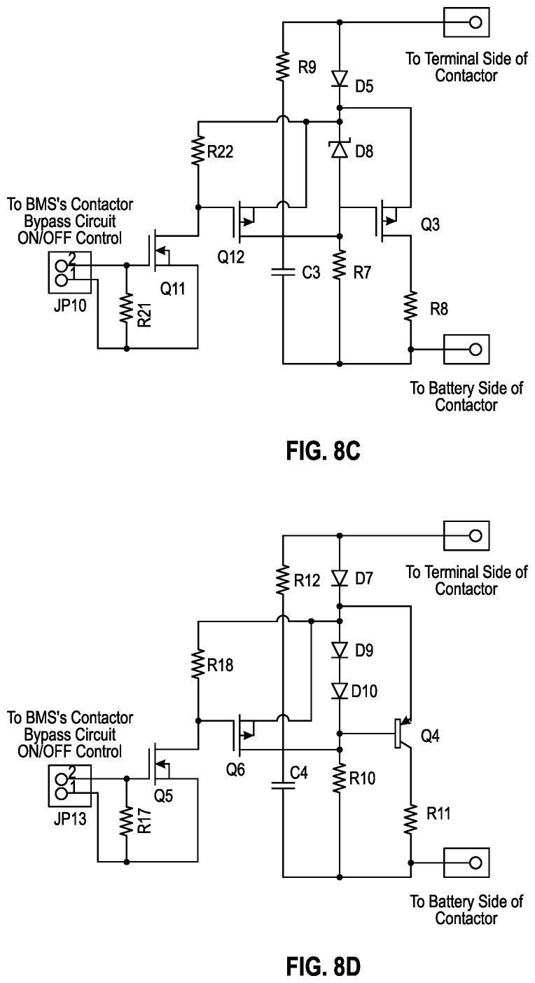

FIGS. 8A-8D illustrate embodiments of an active bypass circuit using a level shifter interface to the BMS 24, to implement a bypass circuit OFF control. In the circuit of FIG. 8A, the shutdown circuit may be implemented using a level shifting circuit made up resistor R19, resistor R20, transistor Q7, and transistor Q8. This circuit may be activated by the BMS 24, which may remove the gate voltage on Q1 and turns off the bypass circuit.

The resistor R4 and capacitor C1 in FIG. 6A and FIG. 8A (and corresponding components in FIGS. 6B-6D and FIGS. 8B-8D), implement a snubber circuit to protect the bypass circuit from voltage transients when the contactor's contacts open under load.

Diode D1 in FIG. 6A and FIG. 8A (and corresponding components in FIGS. 6B-6D and FIGS. 8B-8D), blocks current from being drawn from the battery 12 when the contactor 18a is open.

The bypass circuit may implement a feature to recover a battery that has become over discharged and cannot close the protection contactor when a charger is connected to the battery. It may also provide a shutdown feature to prevent overcharging of the battery and a reverse current flow blocking to prevent discharging of the battery though the bypass circuit. The bypass current may be designed to be any value of current compatible with the battery's chemistry and capacity.

The above described several circuit implementations of an open contactor bypass system. The following will describe several possible variations. While the following represents some number of the possible circuit implementations, it cannot be considered to cover every possible implementation. No component values are specified for the circuits that follow. As is understood in the art, specific component values are a function of the particular type of battery, battery capacity, charger voltage and charging current, and type of control signals available from the BMS, and so on.

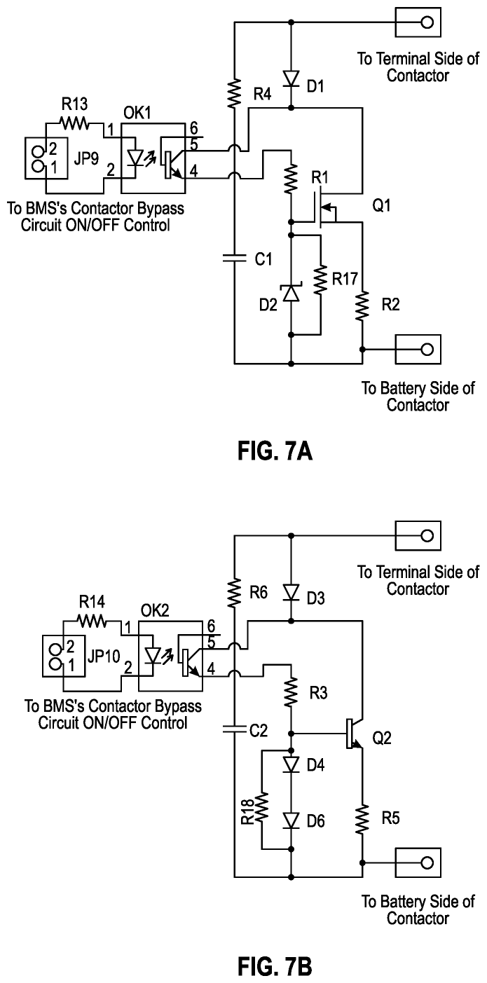

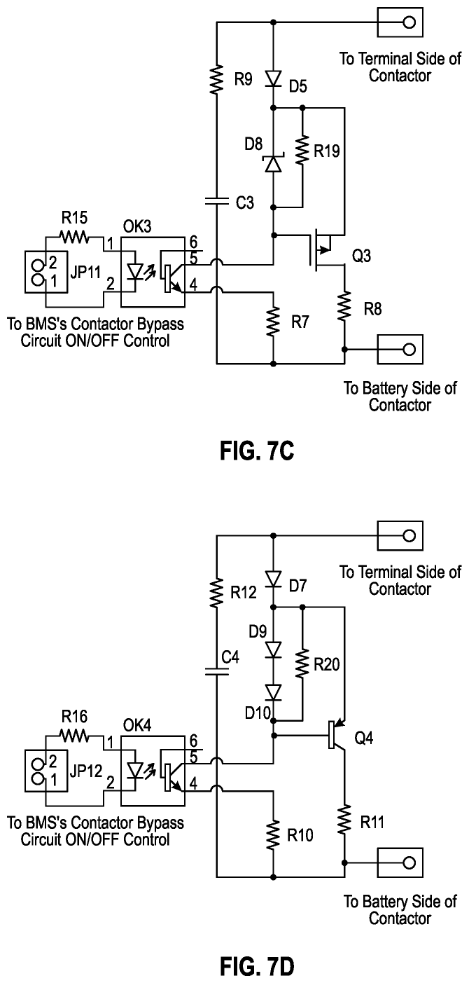

FIGS. 7A-7D illustrate current sources from FIGS. 6A-6D, with an opto-isolator shutdown circuit without bias current when OFF.

In some applications, the current from the bias circuit, while the bypass circuit is shutdown, may not be desirable.

The shutdown circuits of FIGS. 6A-6D may be rearranged to prevent the bias current flow when the shutdown function is active. The shutdown circuit shown in FIGS. 7A-7D may be provided to prevent current flow from the bias circuit when active while removing the gate or base drive from the current regulating transistor. The control signal from the BMS turns OFF the current source as well as turning OFF the current flow in the bias circuitry.

Each of the circuits shown in FIGS. 4A-4D may have other types of shutdown circuits added thereto.

FIGS. 8A-8D illustrate the current sources from FIG. 4A-4D with shutdown circuits based on a level shifter circuit. A level shifting circuit provides a method for a logic signal from a microcontroller, which is typically in the 3 to 5 voltage range, to control voltages at a much higher level. The goal of the level shifting circuit is to affect the gate or base drive of the current regulating transistor. The shutdown circuit shown in FIGS. 8A-8D removes the drive from the gate or the base when a control voltage is applied to the BMS interface transistor.

A feature of the shutdown circuit shown in FIGS. 8A-8D is that the current flow in the bias circuit for the current regulator transistor does not stop when the shutdown function is active. This is the current flow through the resistor and diodes connected to the gate or base of the regulator transistor and is substantially less than the current flow through the regulator transistor, and less than the balance current used the battery's cell balance circuit. This small current may be used as a trickle charge current to keep the battery in a full state of charge while the charger is connected.

In some applications, current from the bias circuit, while the bypass circuit is shutdown, may not be desirable.

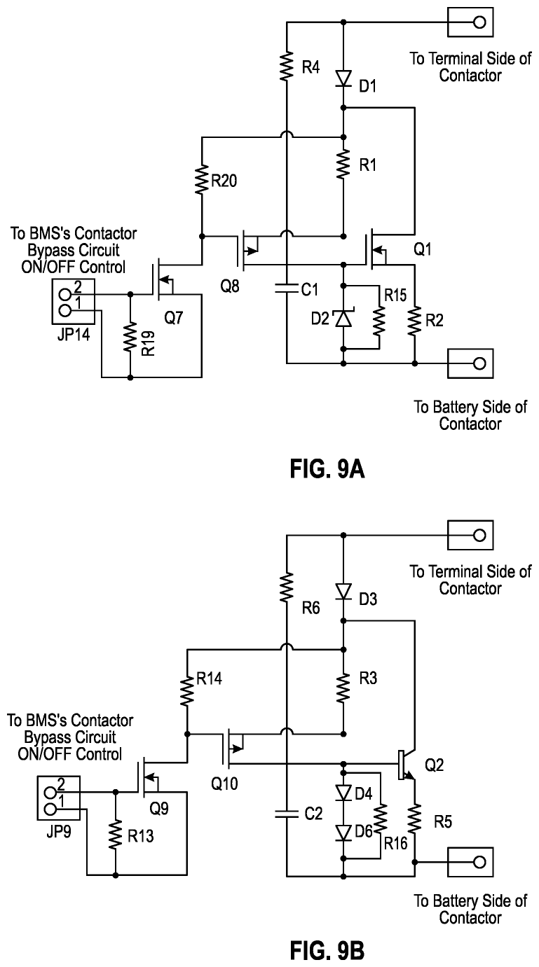

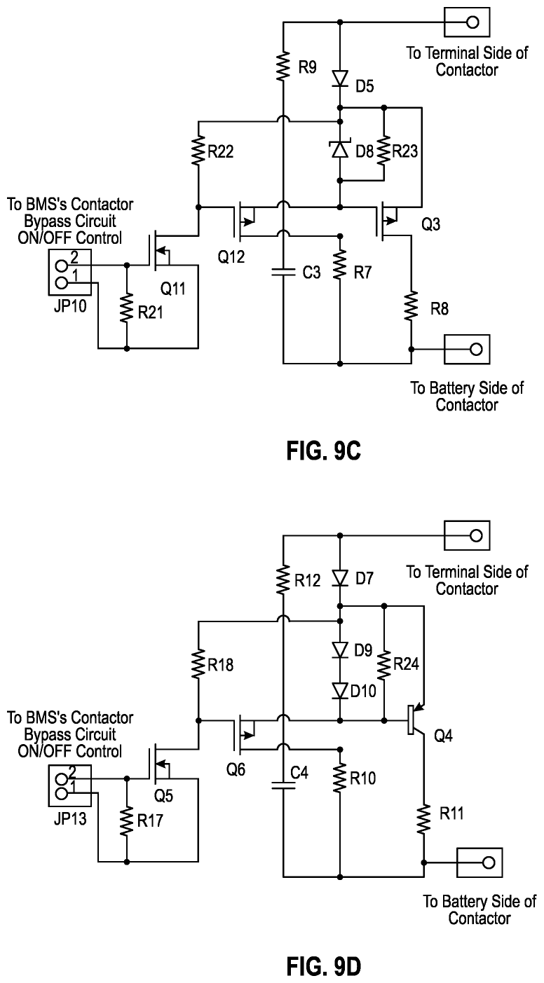

The shutdown circuit illustrated in FIGS. 8A-8D may be rearranged to stop the bias current flow when the shutdown function is active. The shutdown circuit shown in FIGS. 9A-9D may be provided to prevent current flow from the bias circuit when active while removing the gate or base drive from the current regulating transistor. The control signal from the BMS turns OFF the current source as well as turning OFF the current flow in the bias circuitry.

While the shutdown circuits shown in FIGS. 8A-8D and 9A-9D may be composed of a level shifter composed of transistors that is enabled by a voltage applied to the BMS interface transistor, any level shift circuit that can affect the gate or base drive of the current regulating transistor may be considered as a variation of this shutdown control circuit. There are many possible variations of this shutdown scheme using MOSFETs or bipolar transistors that can be enabled by applying a voltage to the BMS interface circuit or removing a voltage from the BMS interface circuit.

It is to be understood that this disclosure is not intended to limit the invention to any particular form described, but to the contrary, the invention is intended to include all modifications, alternatives and equivalents falling within the spirit and scope of the invention. 1. (cancelled)

2. The open contactor bypass circuit of claim 21, wherein the bypass circuit includes means for limiting the charging current through the bypass circuit to a rate not detrimental to charging an over-discharged battery.

3. The open contactor bypass circuit of claim 21, wherein the bypass circuit comprises a diode in series with a resistor.

4. The open contactor bypass circuit of claim 21, including a shutdown circuit for disabling the bypass circuit.

5. The open contactor bypass circuit of claim 4, wherein the shutdown circuit is operable to disable the bypass circuit when the latching contactor is returned to the closed state.

6. The open contactor bypass circuit of claim 5, wherein the shutdown circuit is operable to disable the bypass circuit under control of the battery management system.

7. The open contactor bypass circuit of claim 21, wherein the battery management system includes a battery cell voltage balancing circuit for selectively diverting charging current around selective cells of the battery.

8. The open contactor bypass circuit of claim 21, wherein the bypass circuit comprises a transistor implemented constant current source to maintain the charging current substantially constant over a range of charger voltages.

9. The open contactor bypass circuit of claim 8, wherein the battery management system includes a shutdown circuit, the shutdown circuit adapted to selectively disable the transistor implemented constant current source, to prevent charging current from flowing through the bypass circuit.

10. The open contactor bypass circuit of claim 9, wherein the shutdown circuit is isolated from the transistor implemented constant current source.

11. The open contactor bypass circuit of claim 10, wherein the shutdown circuit is electrically isolated from the transistor implemented constant current source by an optocoupler.

12. The open contactor bypass circuit of claim 10, wherein the shutdown circuit is electrically isolated from the transistor implemented constant current source by a level shifter interface.

13. A battery system comprising:
a battery comprising at least one battery cell;
a latching contactor in series with the battery, wherein the latching contactor is operable alternately between an open state and a closed state;
an open contactor bypass circuit disposed across the latching contactor, the open contactor bypass circuit for permitting charging current from the active battery charger to flow through the bypass circuit, thereby charging the battery, in response to the battery being coupled to the active battery charger and the latching contactor being in an open state.

14. The battery system of claim 13, wherein the open contactor bypass circuitry circuit comprises a resistor connected in series with a diode.

15. The battery system of claim 13, wherein the open contactor bypass circuitry circuit comprises a constant current source to maintain the charging current substantially constant over a range of charger voltages.

16. The battery system of claim 15 wherein:
the battery system includes a battery management system; and
the constant current source is coupled to, and operable upon command of, the battery management system.

17. The battery system of claim 16 including an opto-isolator for coupling the constant current source to the battery management system.

18. The battery system of claim 16, wherein the battery management system includes a shutdown circuit for reducing the current flow through the open contactor bypass circuit.

19. The battery system of claim 18, wherein the shutdown circuit reduces the current flow through the open contactor bypass circuit when the battery is charged and the latching contactor is in an open state.

20. The battery system of claim 16, wherein the battery management system includes a battery cell voltage balancing circuit for selectively diverting charging current around selective cells of the battery.

21. A battery system comprising:
a battery comprising one or more battery cells;
a battery management system;
a latching contactor in series with the battery, wherein the latching contactor is operable alternately between an open state and a closed state under control of the battery management system; and
an open contactor bypass circuit disposed across the latching contactor for permitting charging of the battery by an active battery charger when the latching contactor is in the open state and the battery is in a low state of charge,
wherein the open contactor bypass circuit is activated in response to the latching contactor being in the open state and the battery being coupled to the active battery charger, permitting charging current from the battery charger to flow through the bypass circuit, to bypass the open state contactor and charge the battery to a state of charge sufficient to close the latching contactor.
